(19) United States
(12) Patent Application Publication
(10) Pub. No.: US 2015/0231798 A1
(43) Pub. Date: Aug. 20, 2015

(54) APPARATUS FOR MANUFACTURING THREE-DIMENSIONAL SHAPED OBJECT, METHOD OF MANUFACTURING THREE-DIMENSIONAL SHAPED OBJECT, AND THREE-DIMENSIONAL SHAPED OBJECT

(71) Applicant: SEIKO EPSON CORPORATION, Tokyo (JP)

(72) Inventor: Junichi GOTO, Matsumoto (JP)

(21) Appl. No.: 14/616,132

(22) Filed: Feb. 6, 2015

(30) Foreign Application Priority Data
Feb. 18, 2014 (JP) 2014-028252

(51) Int. Cl. B28B 17/00; B28B 1/00; B29C 67/00

(52) U.S. Cl. CPC B28B 17/0054; B29C 67/0074; B29C 67/0096; B28B 1/001; B29K 2105/251

(57) ABSTRACT

An apparatus for manufacturing a three-dimensional shaped object manufactures a three-dimensional shaped object by successively laying down unit layers formed using a three-dimensional shaping composition including a three-dimensional shaping powder, and has a shaping part where the three-dimensional shaped object is shaped, a layer forming part that forms layers constituted of the three-dimensional shaping composition on the shaping part, and a removal part that removes the three-dimensional shaping composition that has stuck to the layer forming part.

### CROSS-REFERENCE TO RELATED APPLICATIONS

This application claims priority to Japanese Patent Application No. 2014-028252 filed on Feb. 18, 2014. The entire disclosure of Japanese Patent Application No. 2014-028252 is hereby incorporated herein by reference.

### BACKGROUND

1. Technical Field

The present invention relates to an apparatus for manufacturing a three-dimensional shaped object, a method of manufacturing a three-dimensional shaped object, and a three-dimensional shaped object.

2. Related Art

An apparatus for manufacturing a three-dimensional shaped object with which a three-dimensional object is shaped while a powder is being hardened with a binding solution is known (for example, see Japanese Laid-Open Patent Publication No. 2005-150556). With such a manufacturing apparatus, the three-dimensional object is shaped by repetition of the following operations. First, a powder is spread thin using a blade to form a powder layer, and a binding solution is discharged onto a desired portion of the powder layer, thereby causing the powder to bind together. Consequently, in the powder layer, only the portion onto which the binding solution is discharged will bind, and a thin, planar member (hereinafter, a “unit layer”) is formed. Thereafter, another powder layer is formed thin on that powder layer, and the binding solution is discharged onto a desired portion. Consequently, a new unit layer is formed also on the portion where the binding solution is discharged, of the new powder layer that has been formed. At this time, the binding solution that is discharged onto the powder layer soaks in and reaches the unit layer that was formed previously; therefore, the new unit layer that is formed is also bound to the unit layer that was formed previously. Repeating such operations and successively laying the thin, planar unit layers down one layer at a time makes it possible to shape the three-dimensional object.

Such a three-dimensional shaping technique (apparatus for manufacturing a three-dimensional shaped object) only requires three-dimensional shape data of the object intended to be shaped in order to be able to bind the powder and promptly carrying out the shaping, and obviates the need for such actions as creating a mold in advance of the shaping; therefore, the three-dimensional object can be shaped both quickly and inexpensively. Moreover, because the thin, planar unit layers are successively laid down one layer at a time, even a complex object, e.g., one that has an internal structure can be formed as an integrally shaped object, without being divided into a plurality of components.

With a conventional apparatus for manufacturing a three-dimensional shaped object, however, the powder ends up sticking to the blade (a layer forming part); this stuck powder hinders the formation of a powder layer of uniform thickness and has made it difficult to manufacture a three-dimensional shaped object with high dimensional accuracy.

### SUMMARY

An objective of the present invention is to provide an apparatus for manufacturing a three-dimensional shaped object with which a three-dimensional shaped object can be manufactured with high dimensional accuracy, as well as a method of manufacturing a three-dimensional shaped object with which a three-dimensional shaped object can be manufactured with high dimensional accuracy, and a three-dimensional shaped object that is manufactured with high dimensional accuracy.

Such objectives are achieved by aspects of the present invention described below.

An apparatus for manufacturing a three-dimensional shaped object according to one aspect is adapted to manufacture a three-dimensional shaped object by successively laying down layers formed using a three-dimensional shaping composition including a three-dimensional shaping powder. The apparatus for manufacturing a three-dimensional shaped object includes a shaping part, a layer forming part, and a removal part. The shaping part is configured and arranged to shape the three-dimensional shaped object. The layer forming part is configured and arranged to form the layers, constituted of the three-dimensional shaping composition, on the shaping part. The removal part is configured and arranged to remove the three-dimensional shaping composition that has stuck to the layer forming part.

This makes it possible to manufacture a three-dimensional shaped object with high dimensional accuracy.

In the apparatus for manufacturing a three-dimensional shaped object, preferably, the apparatus has a recovery part configured and arranged to recover the three-dimensional shaping composition that is surplus when the layers are being formed. The removal part is preferably provided to the recovery part.

This makes it possible to more efficiently manufacture the three-dimensional shaped object.

In the apparatus for manufacturing a three-dimensional shaped object, preferably, the recovery part is provided as a separate part from the shaping part.

This makes it possible to more efficiently manufacture the three-dimensional shaped object.

In the apparatus for manufacturing a three-dimensional shaped object, preferably, the layer forming part is preferably one type selected from the group consisting of squeegees and rollers.

This makes it possible to form the layers at a more uniform thickness, and possible to endow the manufactured three-dimensional shaped object with even higher dimensional accuracy.

In the apparatus for manufacturing a three-dimensional shaped object, preferably, the removal in the removal part is preferably at least one type selected from removal by ultrasonic waves, removal by wiping, and removal by static electricity.

This makes it possible to more easily remove any of the three-dimensional shaping composition that has stuck.

A three-dimensional shaped object according to another aspect is manufactured by the apparatus for manufacturing a three-dimensional shaped object according to the above aspects.

This makes it possible to provide a three-dimensional shaped object that has been manufactured with high dimensional accuracy.

A method of manufacturing a three-dimensional shaped object is adapted to manufacture a three-dimensional shaped object by successively laying down layers formed using a three-dimensional shaping composition including a three-dimensional shaping powder. The method of manufacturing a three-dimensional shaped object includes: forming the layers constituted of the three-dimensional shaping composition by a layer forming part; and removing the three-dimensional shaping composition that has stuck to the layer forming part.

This makes it possible to manufacture a three-dimensional shaped object with high dimensional accuracy.

A three-dimensional shaped object according to another aspect is manufactured by the method of manufacturing a three-dimensional shaped object in the present invention.

This makes it possible to provide a three-dimensional shaped object that has been manufactured with high dimensional accuracy.

### BRIEF DESCRIPTION OF THE DRAWINGS

Referring now to the attached drawings which form a part of this original disclosure:

FIG. 1 is a plan view in which a preferred embodiment of an apparatus for manufacturing a three-dimensional shaped object of the present invention is seen in plan view from above;

FIG. 2 is a cross-section view of when the apparatus for manufacturing a three-dimensional shaped object illustrated in FIG. 1 is seen from the right-side direction in the drawing;

FIG. 3 is a cross-sectional view illustrating another example of a removal part;

FIG. 4 is a cross-sectional view illustrating another example of a removal part; and

FIG. 5 is a plan view illustrating another example of an apparatus for manufacturing a three-dimensional shaped object of the present invention.

### DETAILED DESCRIPTION OF EXEMPLARY EMBODIMENTS

Preferred embodiments of the present invention shall now be described in greater detail below, with reference to the accompanying drawings.

### 1. Apparatus for Manufacturing Three-Dimensional Shaped Object

First, the apparatus for manufacturing a three-dimensional shaped object of the present invention shall be described.

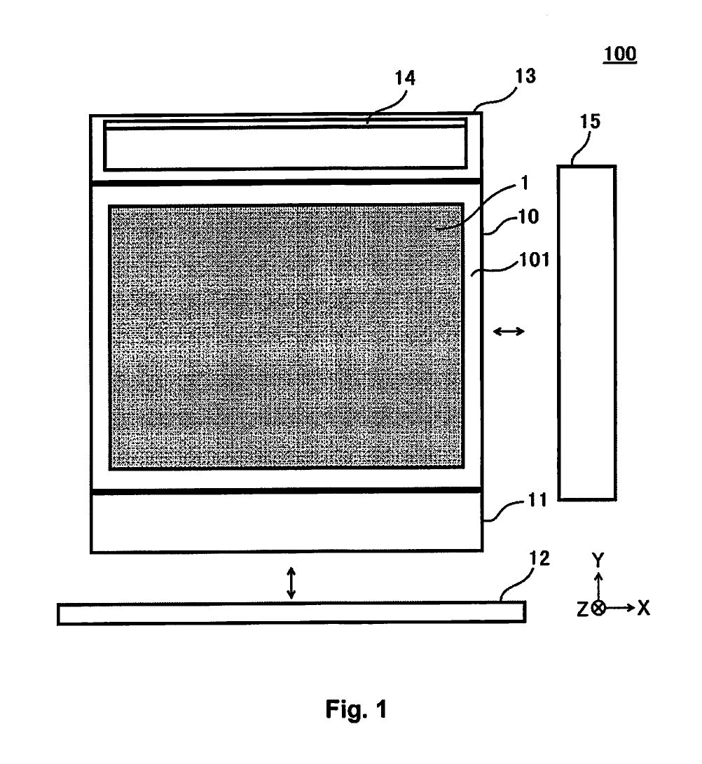

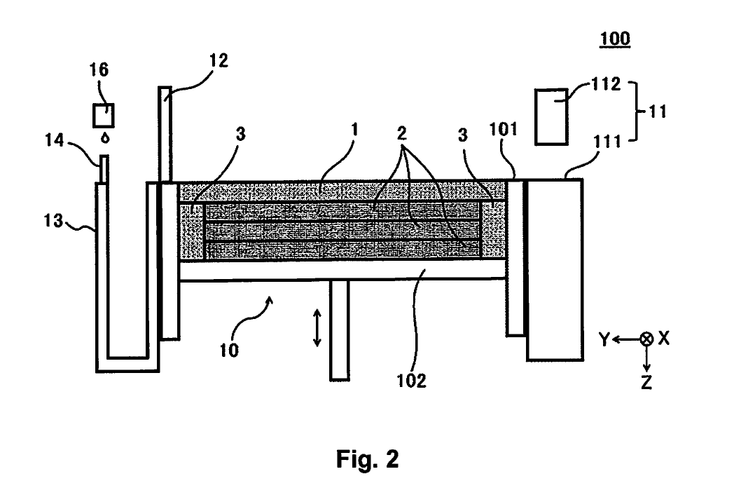

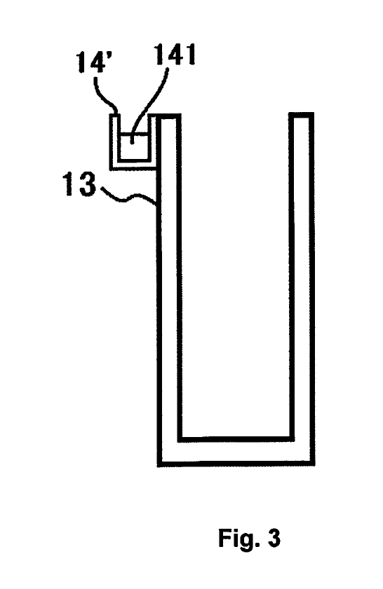

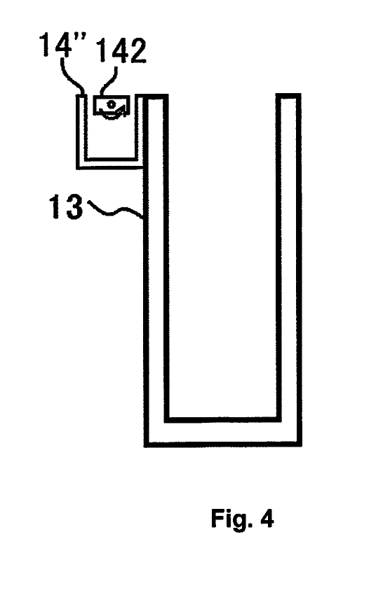

FIG. 1 is a plan view in which a preferred embodiment of an apparatus for manufacturing a three-dimensional shaped object of the present invention is seen in plan view from above; FIG. 2 is a cross-section view of when the apparatus for manufacturing a three-dimensional shaped object illustrated in FIG. 1 is seen from the right-side direction in the drawing; and FIGS. 3 and 4 are cross-sectional views illustrating another example of a removal part.

An apparatus 100 for manufacturing a three-dimensional shaped object is an apparatus for manufacturing a three-dimensional shaped object by successively laying down unit layers 2 that have been formed using a three-dimensional shaping composition that comprises a three-dimensional shaping powder.

The apparatus 100 for manufacturing a three-dimensional shaped object, as illustrated in FIGS. 1 and 2, has: a shaping part 10 where the three-dimensional shaped object is shaped; a supply part 11 for supplying the three-dimensional shaping composition; a squeegee (layer forming part) 12 for using the three-dimensional shaping composition that has been supplied to form a layer 1 of the three-dimensional shaping composition on the shaping part 10; a recovery part 13 for recovering any of the three-dimensional shaping composition that is surplus when the layer 1 has been formed; a wiping part (removal part) 14 for removing any of the three-dimensional shaping composition that has stuck to the squeegee 12; and a discharge section 15 for discharging a binding solution comprising a binding agent onto the layer 1. The three-dimensional shaping composition shall be described in greater below, as shall the binding solution.

The shaping part 10 has a frame 101 and a shaping stage that is provided to a frame 101 interior, as illustrated in FIGS. 1 and 2.

The frame 101 is constituted of a frame-shaped member.

The shaping stage 102 rectangular shape in the XY plane.

The shaping stage 102 is configured so as to be driven in the Z-axis direction by a driving part (not shown).

The layer 1 is formed on a region that is formed of an inner wall surface of the frame 101 and the shaping stage 102.

The shaping part 10 is drivable in the X-axis direction by a driving part (not shown).

The shaping part 10 is then moved in the X-axis direction, i.e., to a discharge section 15 (described below) side, and the binding solution is thereupon discharged onto the layer 1 by the discharge section 15.

The supply part 11 has the function of supplying the three-dimensional shaping composition to inside the apparatus 100 for manufacturing a three-dimensional shaped object.

The supply part 11 has a supply region 111 where the three-dimensional shaping composition is supplied, and a supplying part for supplying the three-dimensional shaping composition to the supply region 111.

The supply region 111 forms a rectangular shape that is elongated in the X-axis direction, and is provided so as to be in contact with one side of the frame 101. The supply region 111 is provided so as to be flush with an upper surface of the frame 101.

The three-dimensional shaping composition having been supplied to the supply region 111 is conveyed to the shaping stage 102 by the squeegee 12 (described below), to form the layer 1.

The squeegee (layer forming part) 12 forms a planar shape that is elongated in the X-axis direction. The squeegee 12 is configured so as to be driven in the Y-axis direction by a driving part (not shown). The squeegee 12 is configured so that a leading end in a minor axis direction thereof is in contact with the upper surface of the frame 101 and with the supply region 111.

The squeegee 12 conveys to the shaping stage 102 the three-dimensional shaping composition that has been supplied to the supply region 111, while also moving in the Y-axis direction, to form the layer 1 on the shaping stage 102.

The recovery part 13 is a box-shaped member having an opened upper surface, and is provided as a separately body from the shaping part 10. The recovery part 13 has the function of recovering any of the three-dimensional shaping composition that is surplus in the formation of the layer 1.

The recovery part 13 is in contact with the frame 101 and is provided so as to face the supply part 11 through the frame 101.

The surplus three-dimensional shaping composition that is carried by the squeegee 12 is recovered at the recovery part 13, and the recovered three-dimensional shaping composition is subjected to re-use.

The wiping part (removal part) 14 is provided to the recovery part 13, and has the function of removing any of the three-dimensional shaping composition that has stuck to the squeegee 12.

The wiping part 14 is constituted of a planar member that is elongated in the X-axis direction, as illustrated in FIG. 1. The wiping part 14 removes the three-dimensional shaping composition that has stuck to the squeegee 12 by being in contact with the squeegee 12 that has moved from the Y-axis direction. In terms of the timing at which the three-dimensional shaping composition is removed, the removal is preferably performed every time a plurality of the 1 are formed, but is even more preferably performed every time the layer 1 is formed. Always implementing the removal after the completion of shaping also makes it possible to maintain the durability of the squeegee 12. The squeegee 12 may be configured so that a vibration is imparted by a piezoelectric element (electrostrictive element), eccentric motor, magnetostrictive element, or the like. Available examples for the material of the wiping part 14 include urethane rubber, silicon rubber, synthetic rubber, metal, plastic, or the like. The wiping part (removal part) 14 is provided in FIG. 2 so as to be parallel to the squeegee 12, but may also be provided at an incline so as to be in contact with the squeegee 12 from a leading end of the wiping part (removal part 14).

A cleaner solution applying part 16 for applying a cleaner solution to the wiping part 14 is provided in order to efficiently remove the three-dimensional shaping composition, as illustrated in FIG. 2. There may also be a plurality of cleaner solution applying part 16 provided. As the cleaner solution, it would be possible to employ a solvent that constitutes the three-dimensional shaping composition. Preferably, the squeegee 12 is washed with water after the completion of the shaping, so as not to be degraded by the cleaner solution.

The discharge section 15 has the function of discharging the binding solution onto the layer 1 that has been formed.

More specifically, when the shaping part 10 is moved in the X-axis direction, with the layer 1 having been formed on the shaping stage 102, and approaches a lower section of the discharge section 15, then the binding solution is discharged from the discharge section 15 onto the layer 1.

The discharge section 15 is fitted with a droplet discharge head for discharging droplets of the binding solution in an inkjet format. The discharge section 15 is also provided with a binding solution supply part (not shown). In the present embodiment, a droplet discharge head of a so-called piezoelectric drive format is employed. A region of nozzles of the droplet discharge head that are arrayed in the Y-direction, which intersects with the direction of movement of the shaping part 10, is provided so as to be able to cover a Y-direction region of the layer 1; the discharge section 15 and the shaping part 10 is moved, and the droplets of the binding solution are discharged. There may be a plurality of discharge sections 15 provided, divided into Y, M, C, K, W, and clear ink.

Also provided to the apparatus 100 for manufacturing a three-dimensional shaped object is a curing part (not shown) for curing the binding solution, in the vicinity of the discharge section 15.

The apparatus 100 for manufacturing a three-dimensional shaped object of such a configuration as described above makes it possible to remove as appropriate the three-dimensional shaping composition that has stuck to the squeegee 12, and therefore makes it possible to manufacture the three-dimensional shaped object with high dimensional accuracy without the formation of the layer 1 being hindered by the stuck three-dimensional shaping composition, as has conventionally been the case.

The description above relates to a case where the squeegee 12 is used as the layer forming part, but there is no limitation to the squeegee, and the layer forming part may instead be, for example, a roller.

Also, the description relates to a case where the wiping part 14 is used as the removal part, but there is no limitation thereto.

For example, the removal part may be a configuration such that a cleaner solution 141 is placed inside an ultrasonic wave generation vessel 14′ in which ultrasonic waves are generated, as illustrated in FIG. 3. In such a configuration, first, the squeegee 12 carrying the surplus three-dimensional shaping composition to the recovery part 13 is immersed in the cleaner solution 141. Then, the ultrasonic waves remove the three-dimensional shaping composition that has stuck to the squeegee 12.

The removal part may also be configuration such as a removal part 14″ provided with an electrostatic generation apparatus 142, as illustrated in FIG. 14. In the configuration depicted, the three-dimensional shaping composition that has stuck to the squeegee 12 is removed by attracting the three-dimensional shaping composition onto the electrostatic generation apparatus 142 with electrostatic force. The electrostatic generation apparatus 142 is configured so as to rotate, and the rotation causes the three-dimensional shaping composition that has been attracted to the electrostatic generation apparatus 142 surface to be recovered in the removal part 14″ interior.

### 2. Method of Manufacturing Three-Dimensional Shaped Object

The method of manufacturing a three-dimensional shaped object of the present embodiment is a method of manufacture using the apparatus 100 for manufacturing a three-dimensional shaped object such as is described above.

More specifically, the three-dimensional shaped object is manufactured in the following manner.

First, the three-dimensional shaping composition is supplied to the supply region 111 by the supplying part 112 (supply step).

Next, the three-dimensional shaping composition that has been supplied to the supply region 111 is carried to the shaping stage 102 by the squeegee 12, and the layer 1 is formed (layer formation step).

Though not particularly limited, the thickness of the layer 1 is preferably 30 to 500 μm, more preferably 70 to 150 μm. This makes it possible to more effectively prevent the occurrence of an undesirable unevenness in the three-dimensional shaped object being manufactured or the like while also making the three-dimensional shaped object have adequately excellent productivity, and makes it possible to give the three-dimensional shaped object particularly excellent dimensional accuracy.

Any of the three-dimensional shaping composition that is surplus after the formation of the layer 1 is recovered at the recovery part 13 (recovery step).

The shaping part 10 on which the layer 1 has been formed is moved in the X-axis direction, and the binding solution is discharged onto the layer 1 from the discharge section 15 (discharge step). Thereafter, the binding solution is cured by the curing part (not shown), thus forming a unit layer 2 and an uncured section 3 (curing step).

When the binding solution is being discharged and then cured, any of the three-dimensional shaping composition that has stuck to the squeegee 12 is removed in the removal part 14 (removal step).

Thereafter, the shaping stage 102 is lowered in the Z-axis direction by an amount commensurate with the thickness of the layer 1 being formed, and each of the aforementioned steps is repeated in the stated order. The three-dimensional shaped object is thereby formed.

The three-dimensional shaped object having been manufactured in the manner described above is endowed with especially high dimensional accuracy.

### 3. Three-Dimensional Shaping Composition

Next, the three-dimensional shaping composition shall be described in greater detail.

The three-dimensional shaping composition is one that comprises the three-dimensional shaping powder and a water-soluble resin.

Each of the components shall be described in greater detail below.

### Three-Dimensional Shaping Powder

The three-dimensional shaping powder is constituted of a plurality of particles.

Any kind of particle can be used as the particles, but the particles are preferably constituted of particles that are porous (porous particles). This makes it possible to cause the binding agent in the binding solution to favorably penetrate into the holes when the three-dimensional shaped object is being manufactured, and consequently enables favorable usage in manufacturing a three-dimensional shaped object that has excellent mechanical strength.

Examples of constituent materials for the porous particles constituting the three-dimensional shaping powder include inorganic materials, organic materials, and composites thereof.

Examples of inorganic materials constituting the porous particles could include a variety of metals or metal compounds. Examples of metal compounds could include: a variety of metal oxides such as silica, alumina, titanium oxide, zinc oxide, zirconium oxide, tin oxide, magnesium oxide, and potassium titanate; a variety of metal hydroxides such as magnesium hydroxide, aluminum hydroxide, and calcium hydroxide; a variety of metal nitrides such as silicon nitride, titanium nitride, and aluminum nitride; a variety of metal carbides such as silicon carbide and titanium carbide; a variety of metal sulfides such as zinc sulfide; carbonates of a variety of metals such as calcium carbonate and magnesium carbonate; sulfates of a variety of metals such as calcium sulfate and magnesium sulfate; silicates of a variety of metals such as calcium silicate and magnesium silicate; phosphates of a variety of metals such as calcium phosphate; borates of a variety of metals such as aluminum borate and magnesium borate; and composites thereof.

Examples of organic materials constituting the porous particles could include synthetic resins and natural polymers, more specific examples being polyethylene resin; polypropylene; polyethylene oxide; polypropylene oxide, polyethylenimine; polystyrene; polyurethane; polyurea; polyester; silicone resin; acrylic silicone resin; polymers for which the constituent monomers are a (meth)acrylic acid ester such as poly(methyl methacrylate); crosspolymers for which the constituent monomers are a (meth)acrylic acid ester such as methyl methacrylate crosspolymer (ethylene acrylic acid copolymer resin or the like); polyamide resins such as nylon 12, nylon 6, or crosspolymer nylon; polyimide; carboxymethyl cellulose; gelatin; starch; chitin; and chitosan.

Of these, the porous particles are preferably constituted of an inorganic material, more preferably constituted of a metal oxide, and even more preferably constituted of silica. This makes it possible to give the three-dimensional shaped object particularly excellent properties such as mechanical strength and light resistance. The effects described above also become more prominent in particular when the porous particles are constituted of silica. Additionally, silica possesses excellent fluidity as well, and therefore is advantageous in forming layers 1 of more highly uniform thickness and also makes it possible to give the three-dimensional shaped object particularly excellent productivity and dimensional accuracy.

A commercially available form of silica can be favorably used. More specific examples include: Mizukasil P-526, Mizukasil P-801, Mizukasil NP-8, Mizukasil P-802, Mizukasil P-802Y, Mizukasil C-212, Mizukasil P-73, Mizukasil P-78A, Mizukasil P-78F, Mizukasil P-87, Mizukasil P-705, Mizukasil P-707, Mizukasil P-707D, Mizukasil P-709, Mizukasil C-402, Mizukasil C-484 (made by Mizusawa Industrial Chemicals); Tokusil U, Tokusil UR, Tokusil GU, Tokusil AL-1, Tokusil GU-N, Tokusil N, Tokusil NR, Tokusil PR, Solex, Fine Seal E-50, Fine Seal T-32, Fine Seal X-30, Fine Seal X-37, Fine Seal X-37B, Fine Seal X-45, Fine Seal X-60, Fine Seal X-70, Fine Seal RX-70, Fine Seal A, Fine Seal B (made by Tokuyama); Sipernat, Carplex FPS-101, Carplex CS-7, Carplex 22S, Carplex 80, Carplex 80D, Carplex XR, Carplex 67 (made by DSL Japan); Syloid 63, Syloid 65, Syloid 66, Syloid 77, Syloid 74, Syloid 79, Syloid 404, Syloid 620, Syloid 800, Syloid 150, Syloid 244, Syloid 266 (made by Fuji Silysia Chemical); and Nipgel AY-200, Nipgel AY-6A2, Nipgel AZ-200, Nipgel AZ-6A0, Nipgel BY-200, Nipgel BY-200, Nipgel CX-200, Nipgel CY-200, Nipseal E-150J, Nipseal E-220A, Nipseal E-200A (made by Tosoh Silica).

The porous particles also preferably have undergone a hydrophobic treatment. In general, the binding agent included in the binding solution will tend to be hydrophobic. As such, having the porous particles be ones that have undergone a hydrophobic treatment makes it possible to cause the binding agent to more favorably penetrate into the holes of the porous particles. As a result, the anchoring effect is more prominent and the resulting three-dimensional shaped object can be given even more excellent mechanical strength. Additionally, when the hydrophobic particles are ones that have undergone a hydrophobic treatment, favorable re-use is possible. In a more detailed description, when the porous particles are ones that have undergone a hydrophobic treatment, then there is decreased affinity between the porous particles and a water-soluble resin (described below), therefore preventing entry into the holes. As a result, in the manufacture of the three-dimensional shaped object, porous particles in regions where the binding solution has not been applied can be recovered at high purity, it being readily possible to remove impurities by washing with water or the like. For this reason, mixing the recovered three-dimensional shaping powder again with the water-soluble resin or the like at a predetermined ratio makes it possible to reliably obtain a three-dimensional shaping powder that has been controlled to a desired composition.

The porous particles constituting the three-dimensional shaping powder may undergo any hydrophobic treatment provided that the hydrophobic treatment raises the hydrophobicity of the porous particles, but a preferable one is to introduce a hydrocarbon group. This makes it possible to give the particles an even higher hydrophobicity. This also makes it possible to easily and reliably impart a higher uniformity in the extent of hydrophobic treatment in each particle or at each site of the particle surfaces (including the surfaces of the hole interiors).

A silane compound comprising a silyl group is preferable as the compound used for the hydrophobic treatment. Specific examples of compounds that can be used for the hydrophobic treatment include hexamethyldisilazane, dimethyldimethoxysilane, diethyldiethoxysilane, 1-propenylmethyldichlorosilane, propyldimethylchlorosilane, propylmethyldichlorosilane, propyltrichlorosilane, propyltriethoxysilane, propyltrimethoxysilane, styrylethyltrimethoxysilane, tetradecyltrichlorosilane, 3-thiocyanate propyltriethoxysilane, p-tolyldimethylchlorosilane, p-tolylmethyldichlorosilane, p-tolyltrichlorosilane, p-tolyltrimethoxysilane, p-tolyltriethoxysilane, di-n-propyldi-n-propoxysilane, diisopropyldiisopropoxysilane, di-n-butyldi-n-butyloxysilane, di-sec-butyldi-sec-butyloxysilane, di-t-butyldi-t-butyloxysilane, octadecyltrichlorosilane, octadecylmethyldiethoxysilane, octadecyltriethoxysilane, octadecyltrimethoxysilane, octadecyldimethylchlorosilane, octadecylmethyldichlorosilane, octadecylmethoxydichlorosilane, 7-octenyldimethylchlorosilane, 7-octenyltrichlorosilane, 7-octenyltrimethoxysilane, octylmethyldichlorosilane, octyldimethylchlorosilane, octyltrichlorosilane, 10-undecenyldimethylchlorosilane, undecyltrichlorosilane, vinyldimethylchlorosilane, methyloctadecyldimethoxysilane, methyldodecyldiethoxysilane, methyloctadecyldimethoxysilane, methyloctadecyldiethoxysilane, n-octylmethyldimethoxysilane, n-octylmethyldiethoxysilane, triacontyldimethylchlorosilane, triacontyltrichlorosilane, methyltrimethoxysilane, methyltriethoxysilane, methyl tri-n-propoxysilane, methylisopropoxysilane, methyl-n-butyloxysilane, methyl tri-sec-butyloxysilane, methyl tri-t-butyloxysilane, ethyltrimethoxysilane, ethyltriethoxysilane, ethyl tri-n-propoxysilane, ethylisopropoxysilane, ethyl-n-butyloxysilane, ethyl tri-sec-butyloxysilane, ethyl tri-t-butyloxysilane, n-propyltrimethoxysilane, isobutyltrimethoxysilane, n-hexyltrimethoxysilane, hexadecyltrimethoxysilane, n-octyltrimethoxysilane, n-dodecyltrimethoxysilane, n-octadecyltrimethoxysilane, n-propyltriethoxysilane, isobutyltriethoxysilane, n-hexyltriethoxysilane, hexadecyltriethoxysilane, n-octyltriethoxysilane, n-dodecyltrimethoxysilane, n-octadecyltriethoxysi lane, 2-{2-(trichlorosilyl)ethyl}pyridine, 4-{2-(trichlorosilyl)ethyl}pyridine, diphenyldimethoxysilane, diphenyldiethoxysilane, 1,3-(trichlorosilylmethyl)heptacosane, dibenzyldimethoxysilane, dibenzyldiethoxysilane, phenyltrimethoxysilane, phenylmethyldimethoxysilane, phenyldimethylmethoxysilane, phenyldimethoxysilane, phenyldiethoxysilane, phenylmethyldiethoxysilane, phenyldimethylethoxysilane, benzyltriethoxysilane, benzyltrimethoxysilane, benzylmethyldimethoxysilane, benzyldimethylmethoxysilane, benzyldimethoxysilane, benzyldiethoxysilane, benzylmethyldiethoxysilane, benzyldimethylethoxysilane, benzyltriethoxysilane, dibenzyldimethoxysilane, dibenzyldiethoxysilane, 3-acetoxypropyltrimethoxysilane, 3-acryloxypropyltrimethoxysilane, allyltrimethoxysilane, allyltriethoxysilane, 4-aminobutyltriethoxysilane, (aminoethylaminomethyl)phenethyltrimethoxysilane, N-(2-aminoethyl)-3-aminopropylmethyldimethoxysilane, N-(2-aminoethyl)-3-aminopropyltrimethoxysilane, 6-(aminohexylaminopropyl)trimethoxysilane, p-aminophenyltrimethoxysilane, p-aminophenylethoxysilane, m-aminophenyltrimethoxysilane, m-aminophenylethoxysilane, 3-aminopropyltrimethoxysilane, 3-aminopropyltriethoxysilane, co-aminoundecyltrimethoxysilane, amyltriethoxysilane, benzooxasilepin dimethyl ester, 5-(bicycloheptenyl)triethoxysilane, bis(2-hydroxyethyl)-3-aminopropyltriethoxysilane, 8-bromooctyltrimethoxysi lane, bromophenyltrimethoxysilane, 3-bromopropyltrimethoxysilane, n-butyltrimethoxysilane, 2-chloromethyltriethoxysilane, chloromethylmethyldiethoxysilane, chloromethylmethyldiisopropoxysilane, p-(chloromethyl)phenyltrimethoxysilane, chloromethyltriethoxysilane, chlorophenyltriethoxysilane, 3-chloropropylmethyldimethoxysilane, 3-chloropropyltriethoxysilane, 3-chloropropyltrimethoxysilane, 2-(4-chlorosulfonylphenyl)ethyltrimethoxysilane, 2-cyanoethyltriethoxysilane, 2-cyanoethyltrimethoxysilane, cyanomethylphenethyltriethoxysilane, 3-cyanopropyltriethoxysilane, 2-(3-cyclohexenyl)ethyltrimethoxysilane, 2-(3-cyclohexenyl)ethyltriethoxysilane, 3-cyclohexenyltrichlorosilane, 2-(3-cyclohexenyl)ethyltrichlorosilane, 2-(3-cyclohexenypethyldimethylchlorosilane, 2-(3-cyclohexenyl)ethylmethyldichlorosilane, cyclohexyldimethylchlorosilane, cyclohexylethyldimethoxysilane, cyclohexylmethyldichlorosilane, cyclohexylmethyldimethoxysilane, (cyclohexylmethyl)trichlorosilane, cyclohexyltrichlorosilane, cyclohexyltrimethoxysilane, cyclooctyltrichlorosilane, (4-cyclooctenyl)trichlorosilane, cyclopentyltrichlorosilane, cyclopentyltrimethoxysilane, 1,1-diethoxy-1-silacyclopenta-3-ene, 3-(2,4-dinitrophenylamino)propyltriethoxysilane, (dimethylchlorosilyl)methyl-7,7-dimethylnorpinane, (cyclohexylaminomethyl)methyldiethoxysilane, (3-cyclopentadienylpropyl)triethoxysilane, N,N-diethyl-3-aminopropyl)trimethoxysilane, 2-(3,4-epoxycyclohexyl)ethyltrimethoxysilane, 2-(3,4-epoxycyclohexyl)ethyltriethoxysilane, (furfuryloxymethyl)triethoxysilane, 2-hydroxy-4-(3-triethoxypropoxy)diphenyl ketone, 3-(p-methoxyphenyl)propylmethyldichlorosilane, 3-(p-methoxyphenyl)propyltrichlorosilane, p-(methylphenethyl)methyldichlorosilane,p-(methylphenethyl)trichlorosilane, p-(methylphenethyl)dimethylchlorosilane, 3-morpholinopropyltrimethoxysilane, (3-glycidoxypropyl)methyldiethoxysilane, 3-glycidoxypropyltrimethoxysilane, 1,2,3,4,7,7,-hexachloro-6-methyldiethoxysilyl-2-norbornene, 1,2,3,4,7,7,-hexachloro-6-triethoxysilyl-2-norbomene, 3-iodopropyltrimethoxysilane, 3-isocyanate propyltriethoxysilane, (mercaptomethyl)methyldiethoxysilane, 3-mercaptopropylmethyldimethoxysilane, 3-mercaptopropyldimethoxysilane, 3-mercaptopropyltriethoxysilane, 3-methacryloxypropylmethyldiethoxysilane, 3-methacryloxypropyltrimethoxysilane, methyl{2-(3-trimethoxysilylpropylamino)ethylamino}-3-propionate, 7-octenyltrimethoxysilane, R—N-α-phenethyl-N′-triethoxysilylpropylurea, S—N-α-phenethyl-N′-triethoxysilylpropylurea, phenethyltrimethoxysilane, phenethylmethyldimethoxysilane, phenethyldimethylmethoxysilane, phenethyldimethoxysilane, phenethyldiethoxysilane, phenethylmethyldiethoxysilane, phenethyldimethylethoxysilane, phenethyltriethoxysilane, (3-phenylpropyl)dimethylchlorosilane, (3-phenylpropyl)methyldichlorosilane, N-phenylaminopropyltrimethoxysilane, N-(triethoxysilylpropyl)dansylamide, N-(3-triethoxysilylpropyl)-4,5-dihydroimidazole, 2-(triethoxysilylethyl)-5-(chloroacetoxy)bicycloheptane, (S)—N-triethoxysilylpropyl-O-menthocarbamate, 3-(triethoxysilylpropyl)-p-nitrobenzamide, 3-(triethoxysilyl)propylsuccinic anhydride, N-{5-(trimethoxysilyl)-2-aza-1-oxo-pentyl}caprolactam, 2-(trimethoxysilylethyl)pyridine, N-(trimethoxysilylethyl)benzyl-N,N,N-trimethylammonium chloride, phenylvinyldiethoxysilane, 3-thiocyanate propyltriethoxysilane, (tridecafluoro-1,1,2,2,-tetrahydrooctyl)triethoxysilane, N-{3-(triethoxysilyl)propyl}phthalamate, (3,3,3-trifluoropropyl)methyldimethoxysilane, (3,3,3-trifluoropropyl)trimethoxysilane, 1-trimethoxysilyl-2-(chloromethyl)phenylethane, 2-(trimethoxysilyl)ethylphenylsulfonyl azide, β-trimethoxysilylethyl-2-pyridine, trimethoxysilylpropyldiethylenetriamine, N-(3-trimethoxysilylpropyppyrrole, N-trimethoxysilylpropyl-N,N,N-tributylammonium bromide, N-trimethoxysilylpropyl-N,N,N-tributylammonium chloride, N-trimethoxysilylpropyl-N,N,N-trimethylammonium chloride, vinylmethyldiethoxysilane, vinyltriethoxysilane, vinyltrimethoxysilane, vinylmethyldimethoxysilane, vinyldimethylmethoxysilane, vinyldimethylethoxysilane, vinylmethyldichlorosilane, vinylphenyldichlorosilane, vinylphenyldiethoxysilane, vinylphenyldimethylsilane, vinylphenylmethylchlorosilane, vinyltriphenoxysilane, vinyltris-t-butoxysilane, adamantylethyltrichlorosilane, allylphenyltrichlorosilane, (aminoethylaminomethyl)phenethyltrimethoxysilane, 3-aminophenoxydimethylvinylsilane, phenyltrichlorosilane, phenyldimethylchlorosilane, phenylmethyldichlorosilane, benzyltrichlorosilane, benzyldimethylchlorosilane, benzylmethyldichlorosilane, phenethyldiisopropylchlorosilane, phenethyltrichlorosilane, phenethyldimethylchlorosilane, phenethylmethyldichlorosilane, 5-(bicycloheptenyl)trichlorosilane, 5-(bicycloheptenyl)triethoxysilane, 2-(bicycloheptyl)dimethylchlorosilane, 2-(bicycloheptyl)trichlorosilane, 1,4-bis(trimethoxysilylethypbenzene, bromophenyltrichlorosilane, 3-phenoxypropyldimethylchlorosilane, 3-phenoxypropyltrichlorosilane, t-butylphenylchlorosilane, t-butylphenylmethoxysilane, t-butylphenyldichlorosilane, p-(t-butyl)phenethyldimethylchlorosilane, p-(t-butyl)phenethyltrichlorosilane, 1,3-(chlorodimethylsilylmethyl)heptacasane, ((chloromethyl)phenylethyl)dimethylchlorosilane, ((chloromethyl)phenylethyl)methyldichlorosilane, ((chloromethyl)phenylethyl)trichlorosilane, ((chloromethyl)phenylethyl)trimethoxysilane, chlorophenyltrichlorosilane, 2-cyanoethyltrichlorosilane, 2-cyanoethylmethyldichlorosilane, 3-cyanopropylmethyldiethoxysilane, 3-cyanopropylmethyldichlorosilane, 3-cyanopropylmethyldichlorosilane, 3-cyanopropyldimethylethoxysilane, 3-cyanopropylmethyldichlorosilane, 3-cyanopropyltrichlorosilane, and fluorinated alkylsilanes; it would also be possible to use one species selected from these or a combination of two or more species selected from these.

Of these, it is preferable to use hexamethyldisilazane for the hydrophobic treatment. This makes it possible to make the particles even more hydrophobic. This also makes it possible to easily and reliably impart a higher uniformity in the extent of hydrophobic treatment in each particle or at each site of the particle surfaces (including the surfaces of the hole interiors).

In a case where a hydrophobic treatment in which a silane compound is used is conducted in a liquid phase, then immersing the particles needing to undergo the hydrophobic treatment in a solution that contains the silane compound makes it possible to cause the desired reaction to proceed favorably and makes it possible to form a chemical adsorption film of the silane compound.

In a case where a hydrophobic treatment in which a silane compound is used is conducted in a gas phase, then exposing the particles needing to undergo the hydrophobic treatment to a vapor of the silane compound makes it possible to cause the desired reaction to proceed favorably and makes it possible to form a chemical adsorption film of the silane compound.

Though not particularly limited, the mean particle size of the particles constituting the three-dimensional shaping powder is preferably 1 to 25 μm, more preferably 1 to 15 μm. This makes it possible to give the three-dimensional shaped object particularly excellent mechanical strength, and also makes it possible to more effectively prevent the occurrence of an undesirable unevenness in the three-dimensional shaped object being manufactured or the like, and to give the three-dimensional shaped object particularly excellent dimensional accuracy. This also makes it possible to impart particularly excellent fluidity to the three-dimensional shaping powder and particularly excellent fluidity to the three-dimensional shaping composition that comprises the three-dimensional shaping powder, and possible to give the three-dimensional shaped object particularly excellent productivity. In the present invention, the “mean particle size” refers to the mean particle size based on volume, and can be found by, for example, adding methanol to a sample and dispersing same for three minutes with an ultrasonic disperser to obtain a dispersion solution and then measuring the dispersion solution with a Coulter counter particle size distribution measuring instrument (TA-II type made by Coulter Electronics Inc.) using a 50-μm aperture.

The Dmax (maximum diameter) of the particles constituting the three-dimensional shaping powder is preferably 3 to 40 μm, more preferably 5 to 30 μm. This makes it possible to give the three-dimensional shaped object particularly excellent mechanical strength, and also makes it possible to more effectively prevent the occurrence of an undesirable unevenness in the three-dimensional shaped object being manufactured or the like, and to give the three-dimensional shaped object particularly excellent dimensional accuracy. This also makes it possible to impart particularly excellent fluidity to the three-dimensional shaping powder and particularly excellent fluidity to the three-dimensional shaping composition that comprises the three-dimensional shaping powder, and possible to give the three-dimensional shaped object particularly excellent productivity. Scattering of light by the particles at the surface of the three-dimensional shaped object being manufactured can also be more effectively prevented.

In the case where the particles are porous particles, then the porosity of the porous particles is preferably 50% or higher, more preferably 55% to 90%. This makes it possible to cause there to be ample space (holes) for the binding agent to enter in and possible to give the porous particles themselves excellent mechanical strength, and consequently makes it possible to impart particularly excellent mechanical strength to the three-dimensional shaped object obtained when the binding resin penetrates into the holes. In the present invention, the “porosity” of the particles refers to the proportion (volume fraction) of holes present in the interior of the particles versus the apparent volume of the particles, and is a value represented by {(ρ₀-ρ)/ρ₀}×100, where ρ(g/cm³) is the density of the particles and ρ₀(g/cm³) is the true density of the constituent material of the particles.

In the case where the particles are porous particles, then the mean hole size (pore diameter) of the porous particles is preferably 10 nm or greater, more preferably 50 to 300 nm. This makes it possible to impart particularly excellent mechanical strength to the three-dimensional shaped object that is ultimately obtained. In a case where a colored binding solution comprising a pigment is used in the manufacture of the three-dimensional shaped object, then the pigment can be favorably retained inside the holes of the porous particles. For this reason, undesirable spreading of the pigment can be prevented, and a high-definition image can be more reliably formed.

The particles constituting the three-dimensional shaping powder may have any shape, but preferably have a spherical shape. This makes it possible to give the three-dimensional shaping powder particularly excellent fluidity and give the three-dimensional shaping composition comprising the three-dimensional shaping powder particularly excellent fluidity, and to give the three-dimensional shaped object particularly excellent productivity, and also makes it possible to more effectively prevent the occurrence of an undesirable unevenness in the three-dimensional shaped object being manufactured or the like, and to give the three-dimensional shaped object particularly excellent dimensional accuracy.

The three-dimensional shaping powder may be one that comprises a plurality of different kinds of particles with which such conditions as described above (for example, the constituent materials of the particles, the type of hydrophobic treatment, and the like) are mutually different.

The void ratio of the three-dimensional shaping powder is preferably 70% to 98%, more preferably 75% to 97.7%. This makes it possible to give the three-dimensional shaped object particularly excellent mechanical strength. Additionally, this makes it possible to give the three-dimensional shaping powder particularly excellent fluidity and give the three-dimensional shaping composition comprising the three-dimensional shaping powder particularly excellent fluidity, and to give the three-dimensional shaped object particularly excellent productivity, and also makes it possible to more effectively prevent the occurrence of an undesirable unevenness in the three-dimensional shaped object being manufactured or the like, and to give the three-dimensional shaped object particularly excellent dimensional accuracy. In the present invention, the “void ratio” of the three-dimensional shaping powder refers to the ratio of the sum of the volume of the holes possessed by all particles constituting the three-dimensional shaping powder and the volume of the voids present between the particles, with respect to the volume of a container of a predetermined volume (for example, 100 mL) in a case where the container is filled with the three-dimensional shaping powder, and is a value presented by {(P₀-P)/P₀}×100, where P(g/cm³) is the bulk density of the three-dimensional shaping powder and P₀(g/cm³) is the true density of the constituent material of the three-dimensional shaping powder.

The rate of content of the three-dimensional shaping powder in the three-dimensional shaping composition is preferably 10 mass % to 90 mass %, more preferably 10 mass % to 58 mass %. This makes it possible to impart particularly excellent mechanical strength to the three-dimensional shaped object that is ultimately obtained, while also imparting ample fluidity to the three-dimensional shaping composition.

### Water-Soluble Resin

The three-dimensional shaping composition is one that comprises the water-soluble resin along with the plurality of particles. Comprising the water-soluble resin makes it possible to bind (temporarily fix) the particles to one another and to effectively prevent any undesirable scattering of the particles and the like. This makes it possible to achieve improvements in safety for workers and in dimensional accuracy of the three-dimensional shaped object being manufactured.

In the present specification, it suffices for the “water-soluble resin” to refer to one that is at least partially soluble in water, but, for example, the solubility to water (mass that is soluble in 100 g of water) at 25° C. is preferably 5 (g/100 g water) or higher, more preferably 10 (g/100 g water) or higher.

Examples of the water-soluble resin include synthetic polymers such as polyvinyl alcohol (PVA), polyvinylpyrrolidone (PVP), sodium polyacrylate, polyacrylamide, modified polyamide, polyethylenimine, and polyethylene oxide; natural polymers such as corn starch, mannan, pectin, agar, alginic acid, dextran, glue, and gelatin; and semisynthetic polymers such as carboxymethyl cellulose, hydroxyethyl cellulose, oxidized starch and modified starch; it would also be possible to use one species selected from these or a combination of two or more species selected from these.

Examples of water-soluble resin products include methylcellulose (Shin-Etsu Chemical: trade name “Metolose SM-15”), hydroxyethyl cellulose (Fuji Chemical Co.: trade name “AL-15”), hydroxypropyl cellulose (Nippon Soda: trade name “HPC-M”), carboxymethyl cellulose (Nichirin Chemical: trade name “CMC-30”), sodium starch phosphate ester (I) (Matsutani Chemical Industry: trade name “Hosuta 5100”), polyvinylpyrrolidone (Tokyo Chemical Industry: trade name “PVP K-90”), methyl vinyl ether/maleic anhydride copolymer (GAF Corp; trade name “AN-139”), polyacrylamide (Wako Pure Chemical Industries), modified polyamide (modified nylon) (manufactured by Toray Industries: trade name “AQnylon”), polyethylene oxide (Steel Chemical: trade name “PEO-1”, Meisei Chemical Works; trade name: “Alkox”), ethylene oxide/propylene oxide random copolymer (Meisei Chemical Works: trade name “Alkox EP”), sodium polyacrylate (Wako Pure Chemical Industries), and carboxyvinyl polymer/cross-linked water-soluble acrylic resin (Sumitomo Seika Chemicals: trade name “Aqupec”).

Of these, a case where the water-soluble resin is a polyvinyl alcohol makes it possible to give the three-dimensional shaped object particularly excellent mechanical strength. Also, adjusting the degree of saponification and degree of polymerization makes it possible to more favorably control the properties of the water-soluble resin (for example, the water solubility, water resistance, and the like) and the properties of the three-dimensional shaping composition (for example, the viscosity, the fixing force of the particles, the wetting properties, and the like). For this reason, the manufacture of a diverse range of three-dimensional shaped objects can be accommodated. A polyvinyl alcohol also offers lower cost and more stable supply among the variety of water-soluble resins. For this reason, the three-dimensional shaped object can be stably manufactured while production costs are also being kept low.

In a case where the water-soluble resin is one that comprises a polyvinyl alcohol, then the degree of saponification of that polyvinyl alcohol is preferably 85 to 90. This makes it possible to curb any decrease in the solubility of the polyvinyl alcohol to water. Therefore, in the case where the three-dimensional shaping composition is one that contains water, any decrease in the adhesion between the adjacent unit layers 2 can be more effectively curbed.

In the case where the water-soluble resin is one that comprises a polyvinyl alcohol, then the degree of polymerization of that polyvinyl alcohol is preferably 300 to 1,000. This makes it possible to impart particularly excellent mechanical strength to each of the unit layers 2 and impart particularly excellent adhesion between the adjacent unit layers 2 in the case where the three-dimensional shaping composition is one that comprises water.

The following effects are obtained in a case where the water-soluble resin is polyvinylpyrrolidone (PVP). Namely, polyvinylpyrrolidone has excellent adhesion to a variety of materials such as glasses, metals, and plastics, and therefore it is possible to impart particularly excellent strength and stability of shape to the portions of the layers 1 where the binding solution is not applied, and to impart particularly excellent dimensional accuracy to the three-dimensional shaped object that is ultimately obtained. Also, polyvinylpyrrolidone exhibits high solubility to a variety of organic solvents, and therefore in a case where the three-dimensional shaping composition comprises an organic solvent, the three-dimensional shaping composition can be given particularly excellent fluidity, layers1 with which any undesirable variance in the thickness has been more effectively prevented can be formed, and the three-dimensional shaped object that is ultimately obtained can be given particularly excellent dimensional accuracy. Moreover, polyvinylpyrrolidone exhibits high solubility to water, as well, and therefore it is possible to easily and reliably remove any of the particles constituting each of the layers 1 that have not been bound by the binding agent in an unbound particle removal step (after the end of shaping). In addition, polyvinylpyrrolidone has an appropriate degree of affinity to the three-dimensional shaping powder, and therefore such entry into the holes as described earlier is unlikely to occur adequately but the wettability to the surface of the particles 63 is comparatively high. For this reason, the function of temporary fixing as described above can be more effectively exerted. Polyvinylpyrrolidone also has excellent affinity with a variety of colorants, and therefore in a case where a binding solution that comprises a colorant is used in a binding solution application step, the colorant can be effectively prevented from spreading undesirably. Moreover, polyvinylpyrrolidone has an antistatic function, and therefore in a case where a powder that is not pasted is used as the three-dimensional shaping composition in the layer formation step, scattering of the powder can be effectively prevented. In a case where a composition that is pasted is used as the three-dimensional shaping composition in the layer formation step, then where the three-dimensional shaping composition paste comprises polyvinylpyrrolidone, bubbles can be effectively prevented from getting trapped in the three-dimensional shaping composition, and defects caused by trapping of bubbles can be more effectively prevented from occurring in the layer formation step.

In a case where the water-soluble resin is one that comprises polyvinylpyrrolidone, then the weight-average molecular weight of that polyvinylpyrrolidone is preferably 10,000 to 1,700,000, more preferably 30,000 to 1,500,000. This makes it possible to more effectively exert the functions described above.

In the three-dimensional shaping composition, the water-soluble resin preferably takes a liquid state (for example, a dissolved state, a molten state, or the like) in at least the layer formation step. This makes it possible to easily and reliably impart high uniformity of thickness to the layers 1 that are formed using the three-dimensional shaping composition.

The rate of content of the water-soluble resin in the three-dimensional shaping composition is preferably 15 vol % or less, more preferably 2 vol % to 5 vol %, relative to the bulk volume of the three-dimensional shaping powder. This makes it possible to ensure broader voids for the binding solution to penetrate into while also amply exerting the functions of the water-soluble resin as described above, and possible to give the three-dimensional shaped object particularly excellent mechanical strength.

### Solvents

The three-dimensional shaping composition may be one that comprises a solvent, in addition to the water-soluble resin and the three-dimensional shaping powder described above. This makes it possible to give the three-dimensional shaping composition particularly excellent fluidity and possible to give the three-dimensional shaped object particularly excellent productivity.

Preferably, the solvent is one that dissolves the water-soluble resin. This makes it possible to impart favorable fluidity to the three-dimensional shaping composition, and makes it possible to more effectively prevent any undesirable variance in the thickness of the layers 1 that are formed using the three-dimensional shaping composition. Also, upon formation of the layers 1 in a state where the solvent has been removed, the water-soluble resin can be stuck to the particles at higher uniformity across the whole of the layers 1, and an undesirable unevenness of composition can be more effectively prevented from occurring. For this reason, any undesirable variance in the mechanical strength at each of the sites of the three-dimensional shaped object that is ultimately obtained can be more effectively prevented from occurring, and the three-dimensional shaped object can be given a higher reliability.

Examples of solvents constituting the three-dimensional shaping composition can include water; alcohol solvents such as methanol, ethanol, and isopropanol; ketone-based solvents such as methylethyl ketone and acetone; glycol ethers such as ethylene glycol monoethyl ether and ethylene glycol monobutyl ether; glycol ether acetates such as propylene glycol 1-monomethyl ether 2-acetate and propylene glycol 1-monoethyl ether 2-acetate; polyethylene glycol, and polypropylene glycol; it would also be possible to use one species selected from these or a combination of two or more species selected from these.

Of these, the three-dimensional shaping composition preferably is one that comprises water. This makes it possible to more reliably dissolve the water-soluble resin, and makes it possible to impart a particularly excellent fluidity to the three-dimensional shaping composition and a particularly excellent uniformity of composition to the layers 1 that are formed using the three-dimensional shaping composition. Water is also easily removed after the formation of the layers 1, and is unlikely to have any adverse effects even in a case where some water remains in the three-dimensional shaped object. Water is additionally advantageous in terms of being safe for the human body and in terms of environmental issues.

In a case where the three-dimensional shaping composition is one that comprises a solvent, then the rate of content of the solvent in the three-dimensional shaping composition is preferably 5 mass % to 75 mass %, more preferably 35 mass % to 70 mass %. This causes the effects from comprising the solvent as described above to be more prominently exerted, and also makes it possible to easily remove the solvent quickly during the steps of manufacturing the three-dimensional shaped object, and therefore is advantageous in terms of improving the productivity of the three-dimensional shaped object.

In particular, in a case where the three-dimensional shaping composition contains water as a solvent, the rate of content of the water in the three-dimensional shaping composition is preferably 20 mass % to 73 mass %, more preferably 50 mass % to 70 mass %. This causes the above such effects to be more prominently exhibited.

### Other Components

The three-dimensional shaping composition may comprise components other than what is described above. Examples of such components could include a polymerization initiator, a polymerization accelerator, a penetration enhancer, a wetting agent (moisturizer), a fixing agent, an anti-mildew agent, an antioxidant, an ultraviolet absorber, a chelating agent, or a pH adjusting agent.

### 4. Binding Solution

Next, the binding solution shall be described in greater detail.

### Binding Agent

The binding solution is one that comprises at least a binding agent.

The binding agent is a component provided with a function for binding the particles by being cured.

Though not particularly limited, the binding agent of such description preferably is hydrophobic (lipophilic). This makes it possible to create higher affinity between the binding solution and the particles in a case where, for example, the particles that are used are ones that have undergone a hydrophobic treatment, and causes application of the binding solution to the layers 1 to enable the binding solution to favorably penetrate into the holes of the particles. As a result, the anchoring effect by the binding agent is favorably exerted and the three-dimensional shaped object that is ultimately obtained can be given excellent mechanical strength. In the present invention, it suffices for a hydrophobic curable resin to have amply low affinity to water, but preferably, for example, the solubility to water at 25° C. is 1 (g/100 g water) or lower.

Examples of the binding agent could include a thermoplastic resin; a thermocurable resin; a variety of photocurable resins such as a visible light-curable resin (the narrow definition of a photocurable resin) that is cured by light in the visible light range, an ultraviolet curable resin, or an infrared curable resin; or an X-ray curable resin; it would also be possible to use one species selected from these or a combination of two or more species selected from these. Of these, it is preferable for the binding agent to be a curable resin, from the standpoint of the mechanical strength of the resulting three-dimensional shaped object, the productivity of the three-dimensional shaped object, and so forth. Of the variety of curable resins, an ultraviolet curable resin (polymerizable compound) is particularly preferable from the standpoint of the mechanical strength of the resulting three-dimensional shaped object, the productivity of the three-dimensional shaped object, the storage stability of the binding solution, and so forth.

Preferably used as an ultraviolet ray-curable resin (polymerizable compound) is one with which an addition polymerization or ring-opening polymerization is initiated by radical species or cation species or the like produced from a photopolymerization initiator by irradiation with ultraviolet rays, thus creating a polymer. Manners of polymerization in addition polymerization include radical, cationic, anionic, metathesis, and coordination polymerization. Manners of polymerization in ring-opening polymerization include cationic, anionic, radical metathesis, and coordination polymerization.

Examples of addition polymerizable compounds include compounds that have at least one ethylenically unsaturated double bond. Compounds that have at least one, preferably two terminal ethylenically unsaturated bonds can be preferably used as an addition polymerizable compound.

Ethylenically unsaturated polymerizable compounds have the chemical form of monofunctional polymerizable compounds and polyfunctional polymerizable compounds, or mixtures thereof. Examples of monofunctional polymerizable compounds include unsaturated carboxylic acids (for example, acrylic acid, methacrylic acid, itaconic acid, crotonic acid, isocrotonic acid, maleic acid, and the like) or esters or amides thereof. An ester of an unsaturated carboxylic acid and an aliphatic polyhydric alcohol compound or an amide of an unsaturated carboxylic acid and aliphatic polyvalent amine compound is used as a polyfunctional polymerizable compound.

It would also be possible to use: a product of an addition reaction between an isocyanate or an epoxy and an unsaturated carboxylic acid ester or amide that has a nucleophilic substituent such as a hydroxyl group, an amino group, or a mercapto group; a product of a dehydration condensation reaction with a carboxylic acid; or the like. It would also be possible to use: the product of an addition reaction between an unsaturated carboxylic acid ester or amide having an electrophilic substituent group such as an isocyanate group or an epoxy group and an alcohol, amine, or thiol; or the product of a substitution reaction between an unsaturated carboxylic acid ester or amide having a leaving group substituent such as a halogen group or a tosyloxy group and an alcohol, amine, or thiol.

A (meth)acrylic acid ester is representative as a specific example of a radical polymerizable compound that is the ester of an unsaturated carboxylic acid and an aliphatic polyhydric alcohol compound; either a monofunctional one or a polyfunctional one could be used.

Specific examples of monofunctional (meth)acrylates include tolyloxyethyl(meth)acrylate, phenyloxyethyl(meth)acrylate, cyclohexyl(meth)acrylate, ethyl(meth)acrylate, methyl(meth)acrylate, isobornyl(meth)acrylate, and tetrahydrofurfuryl(meth)acrylate.

Specific examples of bifunctional(meth)acrylates include ethylene glycol di(meth)acrylate, triethylene glycol di(meth)acrylate, 1,3-butanediol di(meth)acrylate, tetramethylene glycol di(meth)acrylate, propylene glycol di(meth)acrylate, neopentyl glycol di(meth)acrylate, hexanediol di(meth)acrylate, 1,4-cyclohexanediol di(meth)acrylate, tetraethylene glycol di(meth)acrylate, pentaerythritol di(meth)acrylate, and dipentaerythritol di(meth)acrylate.

Specific examples of trifunctional(meth)acrylates include trimethylol propane tri(meth)acrylate, trimethylol ethane tri(meth)acrylate, trimethylolpropane alkylene oxide-modified tri(meth)acrylate, pentaerythritol tri(meth)acrylate, dipentaerythritol tri(meth)acrylate,trimethylol propane tri((meth)acryloyloxypropyl)ether, isocyanuric acid alkylene oxide-modified tri(meth)acrylate, propionic acid dipentaerythritol tri(meth)acrylate, tri((meth)acryloyloxyethyl) isocyanurate, hydroxypivalaldehyde-modified dimethylol propane tri(meth)acrylate, and sorbitol tri(meth)acrylate.

Specific examples of tetrafunctional(meth)acrylates include pentaerythritol tetra(meth)acrylate, sorbitol tetra(meth)acrylate, ditrimethylol propane tetra(meth)acrylate, propionic acid dipentaerythritol tetra(meth)acrylate, and ethoxylated pentaerythritol tetra(meth)acrylate.

Specific examples of pentafunctional(meth)acrylates) include sorbitol penta(meth)acrylate, and dipentaerythritol penta(meth)acrylate.

Specific examples of hexafunctional(meth)acrylates include dipentaerythritol hexa(meth)acrylate, sorbitol hexa(meth)acrylate, phosphazene alkylene oxide-modified hexa(meth)acrylate, and captolactone-modified dipentaerythritol hexa(meth)acrylate.

Examples of polymerizable compounds other than(meth)acrylates include itaconic acid esters, crotonic acid esters, isocrotonic acid esters, and maleic acid esters.

Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetradicrotonate.

Examples of isocrotonic acid esters include ethylene glycol diisocrotonate, pentaerythritol diisocrotonate, and sorbitol tetraisocrotonate.

Examples of maleic acid esters include ethylene glycol dimaleate, triethylene glycol dimaleate, pentaerythritol dimaleate, and sorbitol tetramaleate.

Examples of other esters that can be used also include: the aliphatic alcohol esters disclosed in Japanese Examined Patent Publication 46-27926, Japanese Examined Patent Publication 51-47334, and Japanese Unexamined Patent Publication 57-196231; those having an aromatic backbone disclosed in Japanese Unexamined Patent Publication 59-5240, Japanese Unexamined Patent Publication 59-5241, and Japanese Unexamined Patent Publication 2-226149; and the one containing an amino group disclosed in Japanese Unexamined Patent Publication 1-165613.

Specific examples of monomers of amides of unsaturated carboxylic acids and aliphatic polyvalent amine compounds include methylene bisacrylamide, methylenebismethacrylamide, 1,6-hexamethylene bisacrylamide, 1,6-hexamethylene bismethacrylamide, diethylene triamine trisacrylamide, xylylene bisacrylamide, and xylylene bismethacrylamide.

Another example of a preferable amide monomer would be the one having a cyclohexylene structure disclosed in Japanese Examined Patent Publication 54-21726.

Urethane-based addition polymerizable compounds manufactured using an addition reaction between an isocyanate and a hydroxyl group are also favorable, and a specific example thereof could be a vinyl urethane compound containing two or more polymerizable vinyl groups in a molecule obtained by adding a vinyl monomer containing a hydroxyl group represented in formula (1) below to a polyisocyanate compound having two or more isocyanate groups in one molecule, as is disclosed in Japanese Examined Patent Publication 48-41708.

CH₂═C(R¹)COOCH₂CH(R²)OH (1)

(where R¹ and R² in the formula each independently indicate an H or CH3)

In the present invention, a cationic ring-opening polymerizable compound having one or more cyclic ether groups such as an epoxy group or an oxetane group in the molecule can be favorably used as an ultraviolet ray-curable resin (polymerizable resin).

Examples of cationic polymerizable compounds include curable compounds comprising a ring-opening polymerizable group, among which heterocyclic group-containing curable compounds are particularly preferable. Examples of such curable compounds include an epoxy derivative, an oxetane derivative, a tetrahydrofuran derivative, a cyclic lactone derivative, a cyclic carbonate derivative, an oxazoline derivative, or other such cyclic imino ethers, or vinyl ethers; of these, epoxy derivatives, oxetane derivatives, and vinyl ethers are preferable.

Examples of preferable epoxy derivatives include monofunctional glycidyl ethers, polyfunctional glycidyl ethers, monofunctional alicyclic epoxies, and polyfunctional alicyclic epoxies.

Specific compounds for glycidyl ethers can be illustratively exemplified by diglycidyl ethers, (for example, ethylene glycol diglycidyl ether, bisphenol A diglycidyl ether, and the like), trifunctional or higher glycidyl ethers (for example, trimethylol ethane triglycidyl ether, trimethylol propane triglycidyl ether, glycerol triglycidyl ether, triglycidyl trishydroxyethyl isocyanurate, or the like), tetrafunctional or higher glycidyl ethers (for example, sorbitol tetraglycidyl ether, pentaerythritol tetraglycyl ether, cresol novolac resin polyglycidyl ether, phenolnovolac resin polyglycidyl ether, and the like), alicyclic epoxies (for example, Celloxide 2021P, Celloxide 2081, Epolead GT-301, and Epolead GT-401 (Daicel Chemical Industries)), EHPE (Daicel Chemical Industries), phenol novolac resin polycyclohexyl epoxy methyl ether or the like), and oxetanes (for example, OX-SQ, PNOX-1009 (Toagosei), and the like).

As a polymerizable compound, an alicyclic epoxy derivative could be preferably used. An “alicyclic epoxy group” is a term for a moiety obtained when a double bond of a cycloalkene group such as a cyclopentene group or cyclohexene group is epoxidized with a suitable oxidizing agent such as hydrogen peroxide or a peroxy acid.

Preferable alicyclic epoxy compounds include polyfunctional alicyclic epoxies having two or more cyclohexene oxide groups or cyclopentene oxide groups in one molecule. Specific examples of alicyclic epoxy compounds include 4-vinylcyclohexene dioxide, (3,4-epoxycyclohexyl)methyl-3,4-epoxycyclohexyl carboxylate, di(3,4-epoxycyclohexyl) adipate, di(3,4-epoxycyclohexylmethyl)adipate, bis(2,3-epoxycyclopentyl)ether, di(2,3-epoxy-6-methylcyclohexylmethyl)adipate, and dicyclopentadiene dioxide.

A glycidyl compound having a normal epoxy group without an alicyclic structure in the molecule could be used either independently or in combination with an aforementioned alicyclic epoxy compound.

Examples of such normal glycidyl compounds could include glycidyl ether compounds and glycidyl ester compounds, but it is preferable to use a glycidyl ether compound in combination.

Specific examples of glycidyl ether compounds include: an aromatic glycidyl ether compound such as 1,3-bis(2,3-epoxypropyloxy)benzene, a bisphenol A epoxy resin, a bisphenol F epoxy resin, a phenol novolac epoxy resin, a cresol novolac epoxy resin, and a trisphenol methane epoxy resin; and an aliphatic glycidyl ether compound such as 1,4-butanediol glycidyl ether, glycerol triglycidyl ether, propylene glycol diglycidyl ether, and trimethylol propane tritriglycidyl ether. Examples of a glycidyl ester could include a glycidyl ester of linoleic acid dimers.

As a polymerizable compound, it would be possible to use a compound that has an oxetanyl group, which is a four-membered cyclic ether (this compound also being called simply an “oxetane compound” below). An oxetanyl group-containing compound is a compound that has one or more oxetanyl groups in one molecule.

The rate of content of the binding agent in the binding solution is preferably 80 mass % or more, more preferably 85 mass % or more. This makes it possible to impart particularly excellent mechanical strength to the three-dimensional shaped object that is ultimately obtained.

### Other Components

The binding solution may also be one that comprises components other than those described above. Examples of such components can include a variety of colorants such as a pigment or a dye, a dispersant, a surfactant, a polymerization initiator, a polymerization accelerator, a solvent, a penetration enhancer, a wetting agent (moisturizer), a fixing agent, an anti-mildew agent, a preservative, an antioxidant, an ultraviolet absorber, a chelating agent, a pH adjusting agent, a thickener, a filler, an aggregation inhibitor, or a defoamer.

In particular, when the binding solution comprises a colorant, this makes it possible to obtain a three-dimensional shaped object that has been colored so as to correspond to the color of the colorant.

In particular, comprising a pigment as a colorant makes it possible to impart favorable light resistance to the binding solution and the three-dimensional shaped object. For the pigment, it would be possible to use an inorganic pigment or an organic pigment.

Examples of inorganic pigments include: carbon blacks (CI Pigment Black 7) such as furnace black, lamp black, acetylene black and channel black; iron oxide, or titanium oxide; from which one kind can be selected for use, or two or more kinds can be combined for use.

Of these inorganic pigments, titanium oxide is preferable because of the preferable white color exhibited thereby.

Examples of inorganic pigments include: an azo pigment such as an insoluble azo pigment, a condensed azo pigment, azo lake, or chelate azo pigment; a polycyclic pigment such as a phthalocyanine pigment, a perylene or perynone pigment, an anthraquinone pigment, a quinacridone pigment, a dioxane pigment, a thioindigo pigment, an isoindolinone pigment, or a quinophthalone pigment; dye chelate (for example, a basic dye chelate or an acidic dye chelate, or the like); a color lake (a basic dye lake or an acidic dye lake); a nitro pigment; a nitroso pigment; aniline black; or a daylight fluorescent pigment; it would also be possible to use one species selected from these or a combination of two or more species selected from these.

More specifically, examples of carbon blacks that are used as pigments for the color black include: No. 2300, No. 900, MCF88, No. 33, No. 40, No. 45, No. 52, MA7, MA8, MA100, No. 2200B, and the like (Mitsubishi Chemical); Raven 5750, Raven 5250, Raven 5000, Raven 3500, Raven 1255, Raven 700, and the like (Carbon Columbia); Regal 400R, Regal 330R, Regal 660R, Mogul L, Monarch 700, Monarch 800, Monarch 880, Monarch 900, Monarch 1000, Monarch 1100, Monarch 1300, Monarch 1400, and the like (Cabot Japan); and Color Black FW1, Color Black FW2, Color Black FW2V, Color Black FW 18, Color Black FW200, Color Black S150, Color Black S160, Color Black S170, Printex 35, Printex U, Printex V, Printex 140U, Special Black 6, Special Black 5, Special Black 4A, Special Black 4 (Degussa).

Examples of pigments for the color white include CI Pigment White 6, 8, and 21.

Examples of pigments for the color yellow include CI Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of pigments for the color magenta include CI Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245, or CI Pigment Violet 19, 23, 32, 33, 36, 38, 43, and 50.

Examples of pigments for the color cyan include CI Pigment Blue 1, 2, 3, 15, 15:1, 15:2, 15:3, 15:34, 15:4, 16, 18, 22, 25, 60, 65, 66, and CI Vat Blue 4 and 60.

Examples of pigments other than those mentioned above include CI Pigment Green 7 and 10, CI Pigment Brown 3, 5, 25, and 26, and CI Pigment Orange 1, 2, 5, 7, 13, 14, 15, 16, 24, 34, 36, 38, 40, 43, and 63.

In a case where the binding solution is one that comprises a pigment, then the mean particle size of those pigment is preferably 300 nm or less, more preferably 50 nm to 250 nm. This makes it possible to impart particularly excellent discharge stability to the binding solution and particularly excellent dispersion stability to the pigment in the binding solution, and also makes it possible to form images of better image quality.

In a case where the binding solution is one that comprises a pigment and the particles are porous, then where d1 (nm) is the mean hole size of the particles and d2 (nm) is the mean particle size of the pigment, the relationship d1/d2>1 is preferably satisfied; more preferably, the relationship 1.1≦d1/d2≦6 is satisfied. Satisfying such relationships makes it possible to favorably retain the pigments in the holes of the particles. For this reason, undesirable spreading of the pigment can be prevented, and a high-definition image can be more reliably formed.

Examples of dyes include an acidic dye, a direct dye, a reactive dye, or a basic dye; it would also be possible to use one species selected from these or a combination of two or more species selected from these.

Specific examples of dyes include CI Acid Yellow 17, 23, 42, 44, 79, and 142, CI Acid Red 52, 80, 82, 249, 254, and 289, CI Acid Blue 9, 45, and 249, CI Acid Black 1, 2, 24, and 94, CI Food Black 1 and 2, CI Direct Yellow 1, 12, 24, 33, 50, 55, 58, 86, 132, 142, 144, and 173, CI Direct Red 1, 4, 9, 80, 81, 225, and 227, CI Direct Blue 1, 2, 15, 71, 86, 87, 98, 165, 199, and 202, CI Direct Black 19, 38, 51, 71, 154, 168, 171, and 195, CI Reactive Red 14, 32, 55, 79, and 249, and CI Reactive Black 3, 4, and 35.

In a case where the binding solution comprises a colorant, then the rate of content of the colorant in the binding solution is preferably 1 mass % to 20 mass %. This produces particularly excellent masking and color reproducibility.

In particular, in a case where the binding solution is one that comprises titanium oxide as a colorant, then the rate of content of the titanium oxide in the binding solution is preferably 12 mass % to 18 mass %, more preferably 14 mass % to 16 mass %. This produces particularly excellent masking.

In a case where the binding solution comprises a pigment, then the pigment can be given more favorable dispersibility when a dispersing agent is also contained. As a result, any partial decline in the mechanical strength due to pigment deviation can be more effectively curbed.

Though not particularly limited, examples of dispersing agents include dispersing agents that are commonly used to prepare pigment dispersions, such as polymeric dispersing agents. Specific examples of polymeric dispersing agents include those composed mainly of one or more species from among polyoxyalkylene polyalkylene polyamine, vinyl-based polymers and copolymers, acrylic polymers and copolymers, polyester, polyamide, polyimide, polyurethane, amino-based polymers, silicon-containing polymers, sulfur-containing polymers, fluorine-containing polymers, and epoxy resins. Examples of commercially available forms of polymeric dispersing agents include Ajinomoto Fine-Techno's Ajisper series, the Solsperse series (Solsperse 36000 and the like) available from Noveon, BYK's Disperbyk series, and Kusumoto Chemicals' Disparlon series.

When the binding solution comprises a surfactant, the three-dimensional shaped object can be given better abrasion resistance. Though not particularly limited, examples of what can be used as a surfactant include polyester-modified silicone or polyether-modified silicone serving as a silicone-based surfactant; of these, it is preferable to use polyether-modified polydimethylsiloxane or polyester-modified polydimethylsiloxane. Specific examples of surfactants include BYK-347, BYK-348, and BYK-UV 3500, 3510, 3530, and 3570 (which are trade names of BYK).

The binding solution may also be one that comprises a solvent. This makes it possible to favorably adjust the viscosity of the binding solution, and makes it possible to give the binding solution particularly excellent stability of discharge by inkjet format even when the binding solution comprises high-viscosity components.

Examples of solvents include: (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, isopropyl acetate, n-butyl acetate, and isobutyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; and alcohols such as ethanol, propanol, and butanol; it would also be possible to use one species selected from these or a combination of two or more species selected from these.

The viscosity of the binding solution is preferably 10 to 25 mPa·s, more preferably 15 to 20 mPa·s. This makes it possible to give the inks particularly excellent stability of discharge by inkjet. In the present specification, “viscosity” refers to a value measured at 25° C. using an E-type viscometer (Visconic ELD made by Tokyo Keiki).

In a case where a plurality of different kinds of binding solutions are used, then it is preferable to use at least a cyan binding solution, a magenta binding solution, and a yellow binding solution. This makes it possible to further broaden the range of color reproduction that can be represented by combining these binding solutions.

Also using a white binding solution and a binding solution of another color in combination produces, for example, the following effects. Namely, it is possible to endow the three-dimensional shaped object that is ultimately obtained with a first region to which the white binding solution is applied and a region which overlaps with the first region and to which a binding solution of a color other than white is applied, provided closer to the outside surface than the first region. This makes it possible for the first region to which the white binding solution is applied to exert masking, and makes it possible to further increase the color saturation of the three-dimensional shaped object.

Using the white binding solution, a black binding solution, and the binding solution of another color in combination also produces, for example, the following effects. Namely, the combined use of the white binding solution makes it possible to represent a color that is fainter and of higher brightness than what can be represented with the binding solution of the other color; and the combined use of the black binding solution makes it possible to represent a color that is fainter and of lower brightness than what can be represented with the binding solution of the other color; and so doing further increases the color saturation of the three-dimensional shaped object and also makes it possible to broaden the width of brightness representation.

A preferred embodiment of the present invention has been described above, but the present invention is in no way limited thereto.

For example, the embodiment above describes a configuration where the recovery part and the shaping part are separate bodies, but there is no limitation thereto, and the recovery part and the shaping part may be configured integrally. In such a case, the squeegee need not be moved, and the layers 1 may be formed by moving the shaping part and the recovery part.

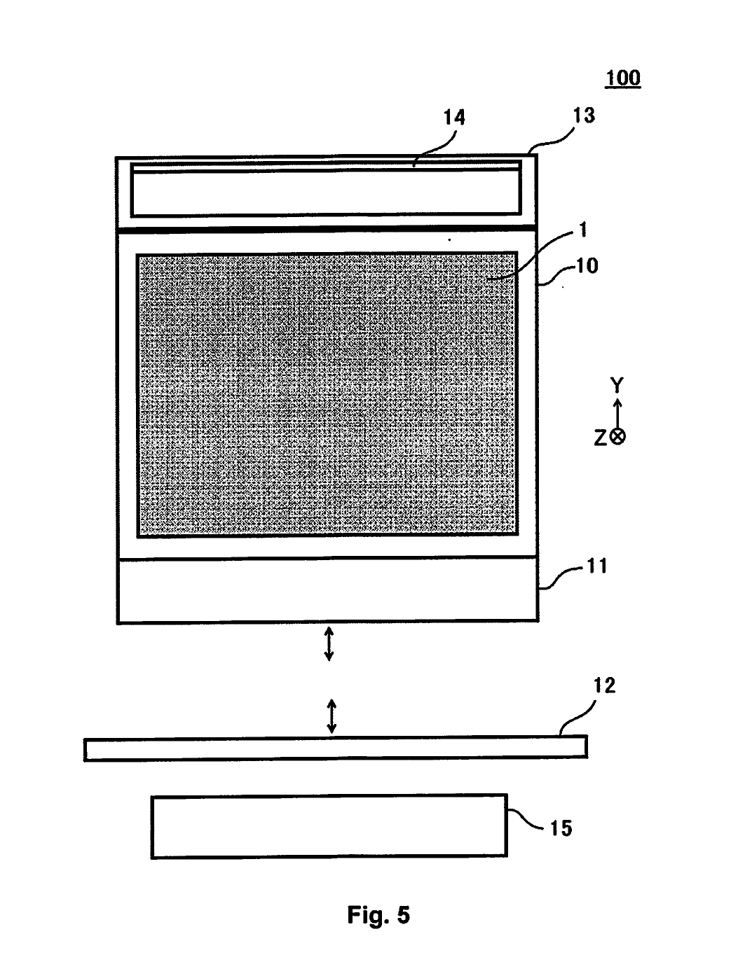

Also, the embodiment above described a configuration where the direction of movement of the squeegee and the direction of movement of the shaping part are orthogonal, but there is no limitation thereto. For example, as illustrated in FIG. 5, the configuration may be one where the direction of movement of the squeegee 12 and the direction of movement of the shaping part 10 are both the Y-axis direction. With the apparatus 100 for manufacturing a three-dimensional shaped object of such description, the configuration is one where the shaping part 10, the supply part 11, the squeegee 12, the recovery part 13, the removal part 14, and the discharge section 15 are arranged side by side in the Y-axis direction, as illustrated in FIG. 5. Also, the configuration would be such that the shaping part 10 and the supply part 11 are integrated, and the supply part 11 also moves along with the movement of the shaping part 10.

In the method of manufacture of the present invention, a pre-treatment step, an intermediate treatment step, and a post-treatment step may be carried out as needed.

An example of a pre-treatment step would be a step for cleaning the shaping stage.

Examples of post-treatment steps would include a cleaning step, a shape adjustment step for deburring and the like, a color step, a cover layer formation step, or a curable resin curing completion step for carrying out a light irradiation treatment or heating treatment in order to ensure curing of any curable resin that is not yet cured.

Also, the embodiment above centered the description on a case where the discharge step is carried out by inkjet, but the discharge step may also be carried out using another method (for example, another print method).

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. An apparatus for manufacturing a three-dimensional shaped object adapted to manufacture a three-dimensional shaped object by successively laying down layers formed using a three-dimensional shaping composition including a three-dimensional shaping powder, the apparatus for manufacturing a three-dimensional shaped object comprising:
a shaping part configured and arranged to shape the three-dimensional shaped object;
a layer forming part configured and arranged to form the layers, constituted of the three-dimensional shaping composition, on the shaping part; and
a removal part configured and arranged to remove the three-dimensional shaping composition that has stuck to the layer forming part.

2. The apparatus for manufacturing a three-dimensional shaped object as set forth in claim 1, further comprising
a recovery part configured and arranged to recover the three-dimensional shaping composition that is surplus when the layers are being formed,
the removal part being provided to the recovery part.

3. The apparatus for manufacturing a three-dimensional shaped object as set forth in claim 2, wherein
the recovery part is provided as a separate part from the shaping part.

4. The apparatus for manufacturing a three-dimensional shaped object as set forth in claim 1, wherein
the layer forming part is one type selected from the group consisting of squeegees and rollers.

5. The apparatus for manufacturing a three-dimensional shaped object as set forth in claim 1, wherein
the removal part is configured and arranged to remove three-dimensional shaping composition by at least one type selected from removal by ultrasonic waves, removal by wiping, and removal by static electricity.

6. A three-dimensional shaped object manufactured by the apparatus for manufacturing a three-dimensional shaped object as set forth in claim 1.

7. A method of manufacturing a three-dimensional shaped object adapted to manufacture a three-dimensional shaped object by successively laying down layers formed using a three-dimensional shaping composition including a three-dimensional shaping powder, the method of manufacturing a three-dimensional shaped object comprising:
forming the layers constituted of the three-dimensional shaping composition by a layer forming part; and
removing the three-dimensional shaping composition that has stuck to the layer forming part.

8. A three-dimensional shaped object manufactured by the method of manufacturing a three-dimensional shaped object as set forth in claim 7.
